(19) United States
(12) Patent Application Publication
(10) Pub. No.: US 2016/0345294 A1
(43) Pub. Date: Nov. 24, 2016

(54) Method and Apparatus for Notification of System Information Changes in a Wireless Communication System

(71) Applicant: Sierra Wireless, Inc., Richmond (CA)

(72) Inventors: Steven John Bennett, Coquitlam (CA); Gustav Gerald Vos, Surrey (CA)

(21) Appl. No.: 15/160,708

(22) Filed: May 20, 2016

Related U.S. Application Data
(60) Provisional application No. 62/165,735, filed on May 22, 2015.

(51) Int. Cl. H04W 68/02; H04W 52/02; H04W 4/00; H04W 76/04; H04W 72/12

(52) U.S. Cl. CPC H04W 68/02; H04W 76/048; H04W 72/12; H04W 4/005; H04W 52/0209; H04W 88/02

(57) ABSTRACT

A method for notifying a plurality of User Equipment (UE) operating under a power saving setting of system information changes to a wireless communication system serving the plurality of UEs, is disclosed. The method includes grouping the plurality of UEs according to a power saving scheme having a plurality of sleep intervals, wherein each UE is activated at the end of each sleep interval for receiving pages; and transmitting a group paging indication to the plurality of UEs at the end of a sleep interval, the group paging indication indicative of SI changes to the wireless communication system.

### FIELD OF THE INVENTION

The present technology pertains to communication systems, and in particular, towards a method and apparatus for notifying user equipment while operating under a power saving setting of system information changes in a wireless communication system.

### BACKGROUND

Wireless communication systems, such as that operating under Long Term Evolution (LTE) wireless standards, can offer high-capacity wireless interfaces to various User Equipment (UEs) such as: mobile phones, data terminals, machine-type-communication (MTC) or machine-to-machine (M2M) equipment, and other terminal types coupled thereto. LTE standards may include protocols for notification of various messages to UEs, such as System Information (SI) messages, in order to advise UEs to update settings in accordance with changes to a communication systems configuration. LTE standards may also include power savings settings, such as a Power Saving Mode (PSM), which attempts to reduce power consumption in UEs by transitioning to a sleep or idle mode to provide power-saving control and functionality. During PSM, the UE can be OFF, but its context can still remain with the wireless communication system. Unfortunately when UEs are in a PSM, they are unable to wake and check for incoming paging messages under current PSM standards. Moreover, UEs must first power up in order to connect to the communication systems before it can receive messages. Accordingly, systems and methods that can notify UEs of system information messages while under a power saving setting, are desired.

This background information is provided for the purpose of making known information believed by the applicant to be of possible relevance to the present technology. No admission is necessarily intended, nor should be construed, that any of the preceding information constitutes prior art against the present technology.

### SUMMARY

An object of the present invention is to provide a method and apparatus for notifying user equipment while operating in a power saving setting, of system information changes to a wireless communication system.

In accordance with an aspect of the present invention, there is provided a method for notifying a plurality of user equipment (UEs) operating under a power saving setting of system information changes to a wireless communication system serving the plurality of UEs. The method comprising: grouping the plurality of UEs according to a power saving scheme having a plurality of sleep intervals, wherein each UE is activated at the end of each sleep interval for receiving pages; and transmitting a group paging indication to the plurality of UEs at the end of a sleep interval, the group paging indication indicative of SI changes to the wireless communication system.

In accordance with another aspect of the present invention, there is provided a network node comprising: a processor; an input interface for coupling to a plurality of user equipment (UEs); a memory communicatively coupled to the processor, the memory having stored thereon statements and instructions which when executed by the processor causes the network node to determine a grouping for the plurality of UEs according to a power saving scheme having a plurality of sleep intervals, and to determine a schedule for transmitting a group paging indication to the plurality of UEs at the end of a sleep interval, the group paging indication indicative of system information changes to a wireless communication system serving the plurality of UEs; and an output interface communicatively coupled to the processor for transmitting instructions to the plurality of UEs to implement the power saving scheme onto the plurality of UEs such that they are activated at the end of each sleep interval to receive pages, and for transmitting the group paging indication to the plurality of UEs according to the schedule.

### BRIEF DESCRIPTION OF THE FIGURES

Further features and advantages of the present invention will become apparent from the following detailed description, taken in combination with the appended drawings, in which:

FIG. 1 illustrates a wireless communication network comprising base stations managing groups of user equipment, according to an embodiment;

FIG. 2 is a flow chart illustrating a method for notifying user equipment of system information changes while operating under a power saving setting, according to an embodiment;

FIG. 3A illustrates a paging schedule determined in accordance with a power saving scheme for a group of user equipment, according to an embodiment;

FIG. 3B illustrates a paging schedule determined in accordance with a power saving scheme for a group of user equipment, according to another embodiment;

FIG. 3C illustrates a paging schedule determined in accordance with a power saving scheme for a group of user equipment, according to yet another embodiment; and

FIG. 4 is a schematic diagram of a hardware device, according to an embodiment.

It will be noted that throughout the appended drawings, like features are identified by like reference numerals.

### DETAILED DESCRIPTION

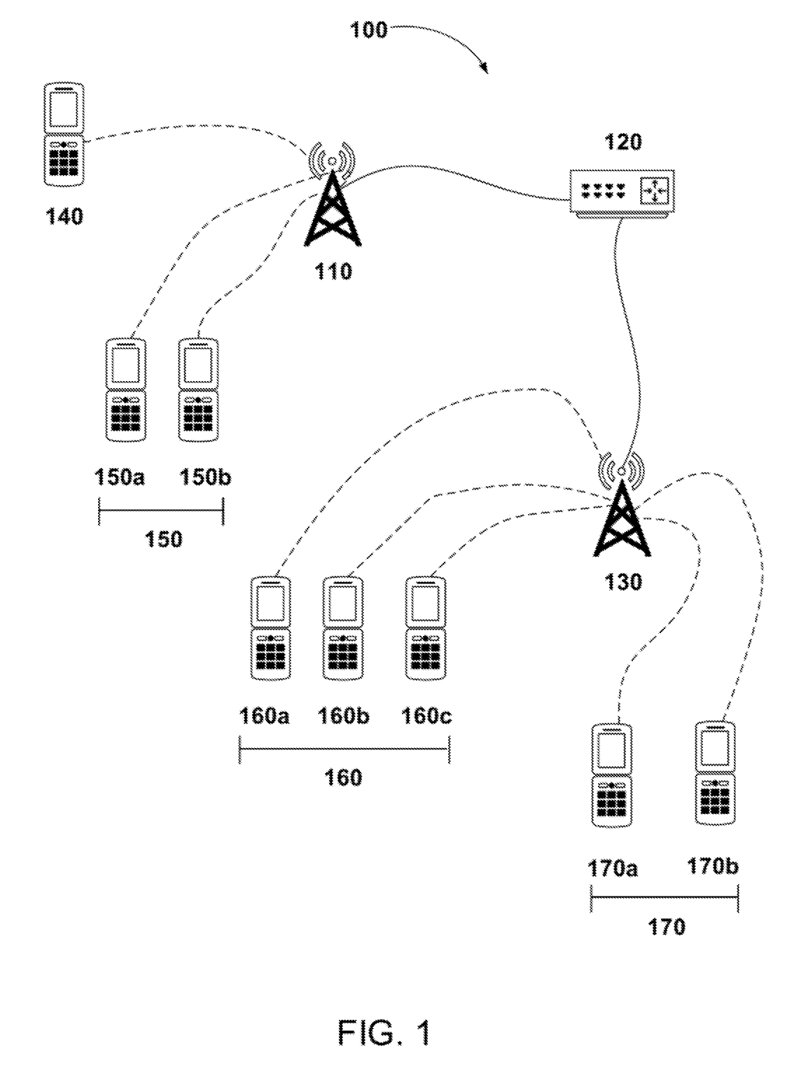

FIG. 1 illustrates a wireless communication system 100 comprising infrastructure equipment 120 communicatively coupled to base stations 110, 130, according to an embodiment. The wireless communication system 100 may operate in accordance with a wireless communication protocol such as LTE, or the like. The infrastructure equipment 120 may perform backbone operations for the communications system 100, and comprise routing and/or processing functionality, for example to process requests or for coupling to data networks, telephone networks, or other communication systems (not shown). Base stations 110, 130 may comprise an evolved Node Bs (eNBs), wireless access points, antennas, or the like, and serve various UEs wirelessly coupled thereto. As shown, Base station 110 serves UEs 140, 150a, and 150b, while base station 130 serves UEs 160a, 160b, 160c, 170a, and 170b. The UEs may comprise M2M/MTC (Machine to Machine/Machine type Communication) devices or Category M devices.

Communication protocols, such as LTE, can support a power saving scheme such as a discontinuous reception (DRX) mode or extended discontinuous reception (eDRX) mode for UEs. DRX is a feature where a UE can idle or sleep for a set duration to conserve power, while “waking up” at set sleep intervals to receive any incoming communications, such as paging messages.

In situations where a communications system services a large number of UEs, base stations may group the UEs according to various power saving schemes, to more efficiently manage the power saving strategy implemented on each UE. Referring back to FIG. 1 for example, base station 110 may manage UE 140 by implementing a first DRX mode thereto, and group UEs 150a and 150b as UE group 150, while implementing a second DRX mode onto UE group 150. Similarly, base station 130 may group UEs 160a, 160b, 160c as UE group 160 according to a third DRX mode, and group UEs 170a and 170b as UE group 170 according to a fourth DRX mode. In this way, communications system 100 can selectively group individual UEs into groups, and more efficiently manage the power saving schemes of the UEs as groups, instead of having to individually manage the power saving scheme of each UE.

Unfortunately, current LTE standards do not provide effective mechanisms for paging a large number of UEs with individual randomly distributed paging occasions over many minutes (for example, to notify of System Information (SI) changes) when they are operating under a power saving setting or sleep mode. Furthermore, UEs operating in a poor coverage area may require a coverage enhancement procedure, where paging messages are successively repeated a large number of times to ensure receipt. These requirements can provide substantial challenges in notifying UEs of potential SI changes. In some cases, it may be desirable to avoid a storm of paging messages for UEs having a relatively longer sleep interval while operating in an enhanced coverage area. For example, in an eDRX cycle that extends from 2.56 s up to 43.69 minutes, it may be necessary to page individually all UEs at the time each would normally wake up. That might be every 2.56 s or only once every 43.69 s, and becomes increasingly problematic as the number of UEs become increasingly large. Accordingly, methods and apparatuses that can notify UEs of system information changes in a communications network, while not subject to one or more limitations above, are desired.

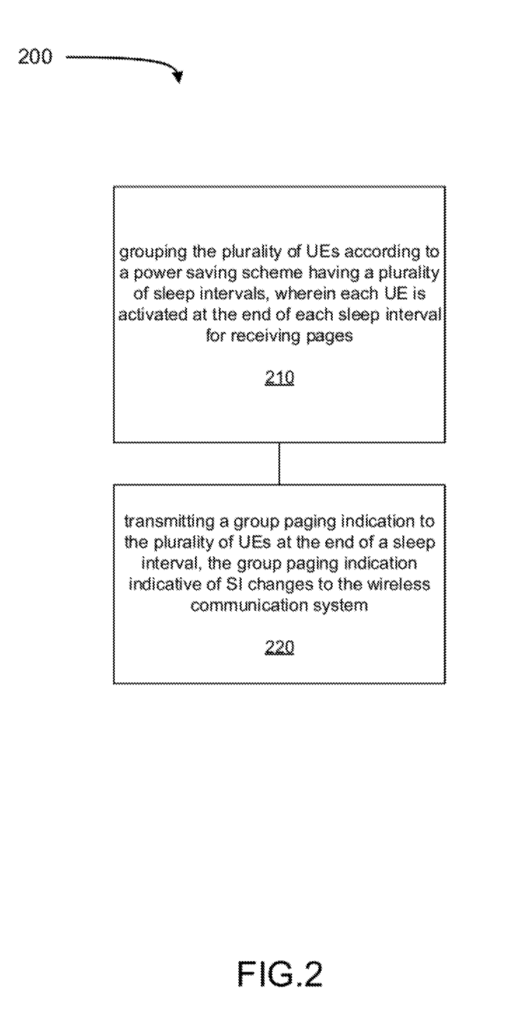

FIG. 2 is a flow chart illustrating a method 200 for notifying a plurality of User Equipment (UE) operating under a power saving setting of System Information (SI) changes to a wireless communication system serving the plurality of UEs, according to an embodiment. For example, method 200 may be applied by base station 130 of the communication system 100, for UE groups 160, 170 which it serves. The method comprises at step 210: grouping the plurality of UEs according to a power saving scheme having a plurality of sleep intervals, wherein each UE is activated at the end of each sleep interval for receiving pages. At step 220: transmitting a group paging indication to the plurality of UEs at the end of a sleep interval, the group paging indication indicative of SI changes to the wireless communication system. As will be described in further detail below, method 200 allows for a communication system to selectively transmit pages to a plurality of UEs it serves while they are operating under a power saving scheme, which may include an eDRX mode.

Regarding step 210, individual UEs may be grouped together according to different power savings schemes, in order to more efficiently manage the power savings schemes of the UEs as UE groups, as opposed to individual UEs. This may be particularly relevant in cases where the number of UEs becomes increasingly large, such as in the case of many machine type communication (MTC) devices. The UE grouping may include implementation of the power saving schemes onto the UEs in the UE grouping (by a base station serving the UE group) through the transmission of corresponding instructions. In this way, all UEs in a UE grouping can synchronously operate on the same power savings scheme to receive coordinated paging messages.

Regarding step 220, the group paging indication may comprise a message or a page sent to a UE group, to inform members of the UE group of a change in the SI of the communications system, for example. Upon receipt of the page, each UE can at the completion of a power saving scheme sleep duration, or idle mode operation, decide to obtain the updated SI parameters, or at some convenient time when it is awake. In this way, UEs can receive notification of SI changes while remaining substantially “asleep” for the entire duration of a power savings scheme, and upon completion of the power savings scheme duration, choose to obtain updated SI parameters to carry out operations over the communications network.

In certain embodiments, step 220 of transmitting the group paging indication to the plurality of UEs comprises simultaneously transmitting pages to each of the UEs, wherein the pages are indicative of SI changes to the wireless communication system. The group paging indication may also comprise a Paging-Radio network Temporary Identifier (P-RNTI) message. The group paging indication may also relate to emergency alerting requiring a quick UE reaction, such as: Earthquake and Tsunami Warning System (ETWS), Commercial Mobile Alert System (CMAS) and Extended Access Barring (EAB).

In certain embodiments, method 200 may further comprise various re-transmissions of group paging indications. For example, the group paging indication may be re-transmitted to the plurality of UEs substantially shortly after the transmission, such as in a paging burst as will be described below in further detail. Additionally, the group paging indication may be re-transmitted to the plurality of UEs at the end of additional sleep intervals. Re-transmissions can help ensure that UEs in a UE group receive the group paging indications, for example when operating in an area having poor signal reception.

In certain embodiments, the group paging indication may comprise a counter for indicating the number of re-transmissions of the group paging indication to the plurality of UEs. This allows a UE to determine whether they are receiving the same notification again, or a new notification corresponding to a new SI change, for example. The counter may comprise a version counter corresponding to a particular SI change, for example

In certain embodiments, the power saving scheme implemented onto the UE group may comprise an extended Discontinuous Reception (eDRX) mode. This may allow for the determination of various sleep intervals, and determination of a corresponding paging schedule, which will be discussed below in further detail. eDRX provides a mechanism for UE power savings due to extended sleep durations up to about 1 hour. Another advantage of eDRX is that substantially more UEs can be served by each base station when infrequent communications are needed, for example, by spreading individual communications over time. UEs in enhanced coverage may also be grouped together so that the communications system can re-transmit group messages or pages indicative of SI changes, and synchronization signals (such as Primary Synchronizing Signals (PSS) and Secondary Synchronizing Signals (SSS), for example) in discrete intervals of time rather than continuously.

In certain embodiments, the power saving scheme can comprise tapering sleep intervals, where each successive sleep interval of the plurality of sleep intervals is the same duration or longer than the previous sleep interval. This reduces the number of potential group paging occasions to reduce network traffic load, and the number of times a UE must temporarily awake to receive any pages and help conserve battery power, as will be further illustrated below.

In certain embodiments, method 200 may further comprise transmitting a paging block. For example, the paging block may comprise sequentially transmitting a plurality of pages to each of the UEs within one sleep interval of the plurality of sleep intervals, the pages indicative of SI changes to the wireless communication system. The paging block may adhere to paging operations for certain UEs operating under legacy communication standards.

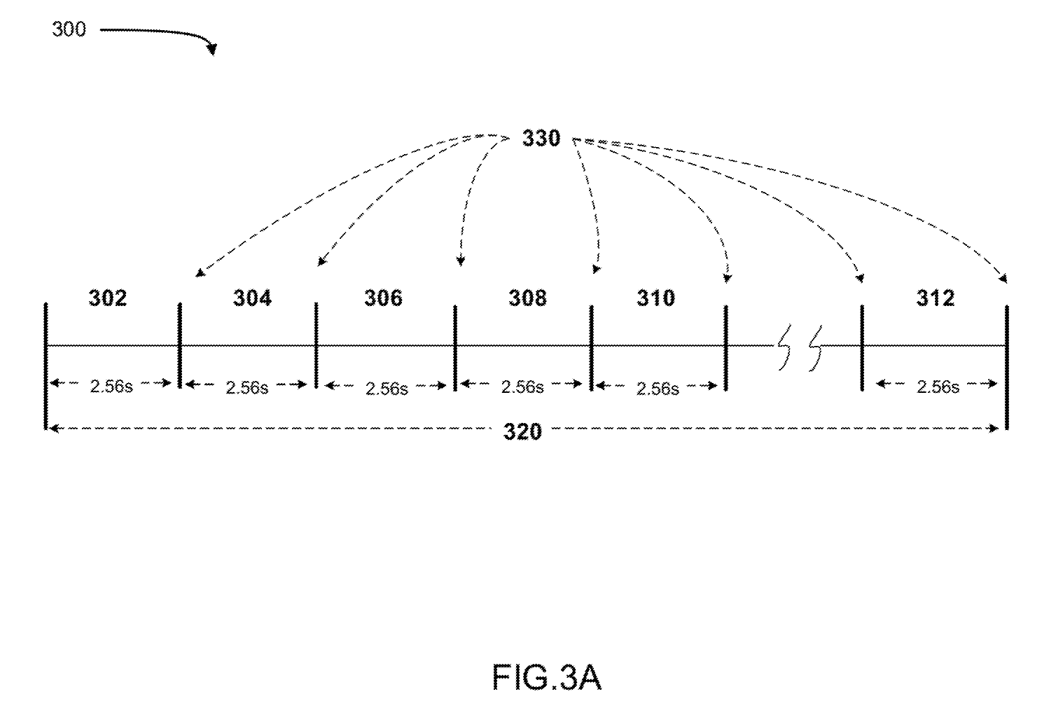

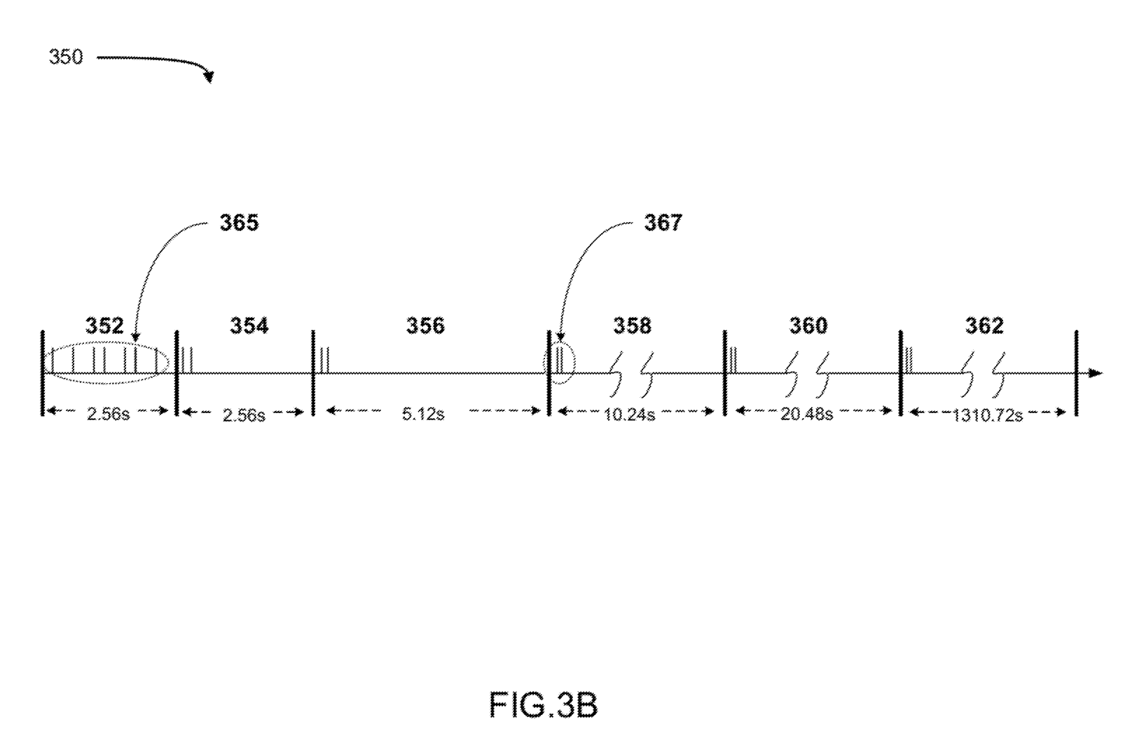

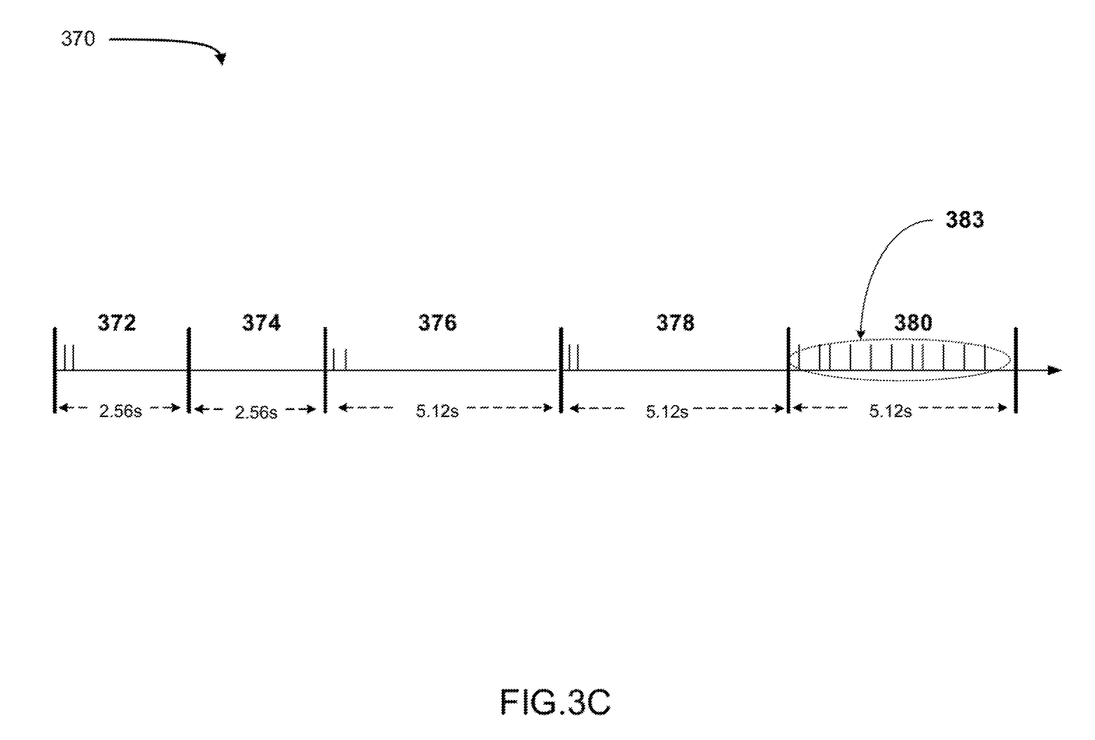

Referring to FIG. 3A, there is shown a paging schedule 300 determined in accordance with a power saving scheme for a group of user equipment, according to an embodiment. As shown, the power saving scheme comprises a sleep duration 320 divided into a plurality of sleep intervals 302, 304, 306, 308, 310, 312 each 2.56 s long in this embodiment, in order to adhere to certain legacy communications standards. For example, when a UE group operates under this power saving scheme, UEs in the group remain substantially “asleep” for the entire a sleep duration 320, but are temporarily activated at the end of every sleep interval 302, 304, 306, 308, 310, 312 to receive any pages or messages from the communications system. Accordingly, a base station may page a UE group on one or more paging occasions 330 corresponding to the end of every sleep interval 302, 304, 306, 308, 310, 312, and UEs in the UE group may receive pages, despite operating under a power savings scheme. For example, a base station may page a UE group during one or as many of paging occasions 330 as desired in order to ensure successful reception of the group paging indication. In some embodiments, a group paging indication can be transmitted during every paging occasion 330. Upon successful reception of the group paging indication, a UE may choose to address the group paging indication (for example, by communicating with a base station to receive updated SI parameters) at the end of the next sleep interval (or paging occasion) where it temporarily awakens, or upon completion of the sleep duration 320 to defer power consumption. Other embodiments (not shown) may comprise more or less sleep intervals, and therefore the UEs would only temporarily awaken at the end of such sleep intervals in accordance with the power saving scheme. For example, a certain power saving scheme may only comprise two sleep intervals, such that a UE operating under this scheme would only awaken once during the scheme, and at the very end of the scheme.

Referring to FIG. 3B, there is shown a paging schedule 350 determined in accordance with a power saving scheme for a group of user equipment, according to another embodiment. Paging schedule 350 is similar to schedule 300 of FIG. 3A, except in that successive sleep intervals 352, 354, 356, 358, 360, 362 are the same duration or longer than previous sleep intervals (i.e. tapering sleep intervals). For example, sleep interval 354 has the same duration as previous sleep interval 352 of 2.56 s, while sleep interval 356 has a duration of 5.12 s which is longer than its previous sleep interval 354. Schedule 350 thus reduces the number of times a network node, such as an eNB, must transmit pages during the maximum power saving scheme sleep duration (such as eDRX), in order to reach all of the UEs. The UEs can wake for group pages on a defined schedule according to the sleep intervals of the corresponding power saving scheme. Additionally, schedule 350 illustrates a paging burst 367 comprising re-transmission of the group paging indication to the plurality of UEs shortly after a transmission at the end of sleep interval 356. Quick re-transmission can help ensure receipt of the group paging indication by UEs in the UE group, for example when respective UEs are in an area having poor signal reception. Further, schedule 350 illustrates a paging block 365 of sequential transmission of a plurality of pages to UEs within sleep interval 352. Implementation of the paging block 365 in paging schedule 350 may ensure compatibility for paging certain devices operating under legacy communication standards, for example.

Referring to FIG. 3C, there is shown a paging schedule 370 determined in accordance with a power saving scheme for a group of user equipment, according to another embodiment. Paging schedule 370 is similar to schedule 300 of FIG. 3A, except in that it comprises only a single increment in sleep interval length (from sleep interval 374 of 2.56 s long, to sleep interval 376 of 5.12 s long). Further, sleep interval 380 comprises a paging block 383 comprising a plurality of pages. For example, paging block 383 may comprise 1024 separate SI pages to be transmitted to UEs operating in an enhanced coverage area, to adhere to various legacy communications standards, or to ensure receipt of the SI pages.

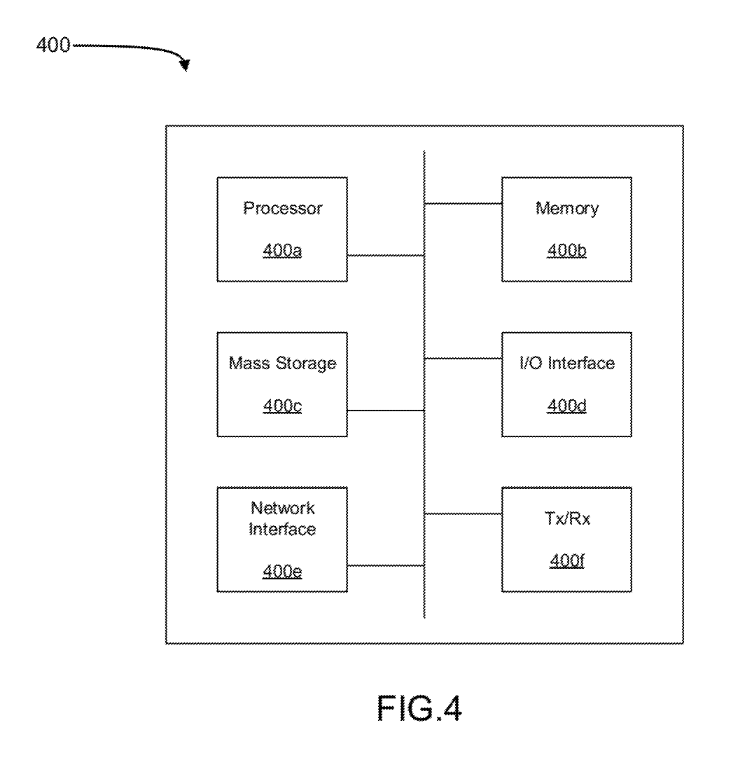

Referring to FIG. 4, there is shown schematic diagram of a hardware device 400 according to another embodiment of the present invention. Hardware device 400 may comprise a network node, such as base stations 110, 130 or infrastructure equipment 120 of FIG. 1, and perform method 200 in certain embodiments.

As shown in FIG. 4, the device 400 includes a processor 400a, memory 400b, non-transitory mass storage 400c, I/O interface 400d, network interface 400e, and a transceiver 400f, all of which are communicatively coupled via bi-directional bus. According to certain embodiments, any or all of the depicted elements may be utilized, or only a subset of the elements. Further, device 400 may contain multiple instances of certain elements, such as multiple processors, memories, or transceivers. Also, elements of the hardware device may be directly coupled to other elements without the bi-directional bus.

The memory 400b may include any type of non-transitory memory such as static random access memory (SRAM), dynamic random access memory (DRAM), synchronous DRAM (SDRAM), read-only memory (ROM), any combination of such, or the like. The mass storage element 400c may include any type of non-transitory storage device, such as a solid state drive, hard disk drive, a magnetic disk drive, an optical disk drive, USB drive, or any computer program product configured to store data and machine executable program code. According to certain embodiments, the memory 400b or mass storage 400c may have recorded thereon statements and instructions executable by the processor 400a for performing any of the aforementioned method steps described above.

Unless defined otherwise, all technical and scientific terms used herein have the same meaning as commonly understood by one of ordinary skill in the art to which this invention belongs.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

We claim:

1. A method for notifying a plurality of User Equipment (UE) operating under a power saving setting of System Information (SI) changes to a wireless communication system serving the plurality of UEs, the method comprising:
grouping the plurality of UEs according to a power saving scheme having a plurality of sleep intervals, wherein each UE is activated at the end of each sleep interval for receiving pages; and
transmitting a group paging indication to the plurality of UEs at the end of a sleep interval, the group paging indication indicative of SI changes to the wireless communication system.

2. The method of claim 1 wherein the step of transmitting the group paging indication to the plurality of UEs comprises simultaneously transmitting pages to each of the UEs, the pages indicative of SI changes to the wireless communication system.

3. The method of claim 1 wherein the group paging indication comprises a Paging-Radio Network Temporary Identifier (P-RNTI) message.

4. The method of claim 1 further comprising re-transmitting the group paging indication to the plurality of UEs substantially shortly after the transmission.

5. The method of claim 1 further comprising re-transmitting the group paging indication to the plurality of UEs at the end of another sleep interval.

6. The method of claim 5 wherein the group paging indication comprises a counter for indicating the number of re-transmissions of the group paging indication to the plurality of UEs.

7. The method of claim 1 wherein the power saving scheme comprises an extended Discontinuous Reception (eDRX) mode.

8. The method of claim 1 wherein the first sleep interval of the plurality of sleep intervals is approximately 2.56 seconds.

9. The method of claim 1 wherein each successive sleep interval of the plurality of sleep intervals is the same duration or longer than the previous sleep interval.

10. The method of claim 1 further comprising sequentially transmitting a plurality of pages to each of the UEs within one sleep interval of the plurality of sleep intervals, the pages indicative of SI changes to the wireless communication system.

11. A network node comprising:
a processor;
an input interface for coupling to a plurality of user equipment (UEs);
a memory communicatively coupled to the processor, the memory having stored thereon statements and instructions which when executed by the processor causes the network node to determine a grouping for the plurality of UEs according to a power saving scheme having a plurality of sleep intervals, and to determine a schedule for transmitting a group paging indication to the plurality of UEs at the end of a sleep interval, the group paging indication indicative of system information (SI) changes to a wireless communication system serving the plurality of UEs; and
an output interface communicatively coupled to the processor for transmitting instructions to the plurality of UEs to implement the power saving scheme onto the plurality of UEs such that they are activated at the end of one or more sleep intervals to receive pages, and for transmitting the group paging indication to the plurality of UEs according to the schedule.

12. The network node of claim 11 wherein the transmission of the group paging indication to the plurality of UEs comprises simultaneously transmitting pages to each of the UEs, the pages indicative of SI changes to the wireless communication system.

13. The network node of claim 11 wherein the group paging indication comprises a Paging-Radio Network Temporary Identifier (P-RNTI) message.

14. The network node of claim 11 wherein the schedule is further for re-transmitting the group paging indication to the plurality of UEs substantially shortly after the transmission.

15. The network node of claim 11 wherein the schedule is further for re-transmitting the group paging indication to the plurality of UEs at the end of another sleep interval.

16. The network node of claim 15 wherein the group paging indication comprises a counter for indicating the number of re-transmissions of the group paging indication to the plurality of UEs.

17. The network node of claim 11 wherein the power saving scheme comprises an extended Discontinuous Reception (eDRX) mode.

18. The network node of claim 11 wherein the first sleep interval of the plurality of sleep intervals is approximately 2.56 seconds.

19. The network node of claim 11 wherein each successive sleep interval of the plurality of sleep intervals is the same duration or longer than the previous sleep interval.

20. The network node of claim 11 wherein the memory comprises further statements and instructions for determining sequential transmission of a plurality of pages to each of the UEs within one sleep interval of the plurality of sleep intervals, and the output interface is for sequentially transmitting the plurality of pages to each of the UEs, the pages indicative of SI changes to the wireless communication system.
